(19) United States
(12) Patent Application Publication
(10) Pub. No.: US 2024/0393115 A1
(43) Pub. Date: Nov. 28, 2024

(54) ROTATION RATE SENSOR WITH A SUBSTRATE HAVING A MAIN EXTENSION PLANE AND WITH AT LEAST ONE MASS OSCILLATOR

(71) Applicant: Robert Bosch GmbH, Stuttgart (DE)

(72) Inventors: Odd-Axel Pruetz, Nuertingen (DE); Martin Putnik, Rottenburg Am Neckar (DE); Robert Ramsperger, Empfingen (DE)

(21) Appl. No.: 18/637,974

(22) Filed: Apr. 17, 2024

(30) Foreign Application Priority Data
May 22, 2023 (DE) 10 2023 204 726.8

(51) Int. Cl. G01C 19/5762; G01C 19/00; G01C 19/5769

(52) U.S. Cl. CPC G01C 19/5762; G01C 19/005; G01C 19/5769

(57) ABSTRACT

A rotation rate sensor. The rotation rate sensor includes a substrate having a main extension plane, and includes at least one mass oscillator. The mass oscillator is connected to a drive structure via one or more spring elements and can be excited to oscillate in an excitation direction running in parallel with the main extension plane. The rotation rate sensor has at least one detection element connected to the mass oscillator and a first and second anchor element connected fixedly to the substrate. The detection element is connected to the first anchor element via a first spring element and is connected to the second anchor element via a second spring element. The detection element can be deflected along a detection direction running in parallel with the main extension plane and perpendicularly to the excitation direction. The first and the second spring element comprise a parallelogram spring element.

### CROSS REFERENCE

The present application claims the benefit under 35 U.S.C. § 119 of German Patent Application No. DE 10 2023 204 726.8 filed on May 22, 2023, which is expressly incorporated herein by reference in its entirety.

### FIELD

The present invention related to a rotation rate sensor.

### BACKGROUND INFORMATION

Micromechanical rotation rate sensors are found in various embodiments in the related art. A common functional principle is the detection of a rotation rate via the action of the Coriolis force associated therewith. For this purpose, one or more mass oscillators are set in periodic movement so that the rotation produces a force acting perpendicularly to both the movement direction and the rotation vector. The periodic movement is in this case maintained by a drive structure, which is coupled to the mass oscillator by means of spring elements. For detecting the Coriolis force, a detection element is provided, which is substantially not moved in the drive direction but, together with the mass oscillator, is mounted in a direction perpendicular to the drive direction so as to be oscillatory relative to the substrate of the micromechanical rotation rate sensor or sensor system. This suspension is provided by means of spring elements, which are anchored to the substrate.

As a result of mechanical stresses or thermal expansion, the distances and relative positions of the anchor points can change, whereby the dynamic properties of the suspended mass oscillator are falsified.

### SUMMARY

It is an object of the present invention to provide a rotation rate sensor which has reduced stress sensitivity with respect to offset, quadrature and sensitivity.

The rotation rate sensor according to an example embodiment of the present invention has the advantage over conventional sensors from the related art that, on the one hand, effects of substrate distortions are reduced and, on the other hand, undesired rotation or tilted oscillation of the detection frame or of the detection element is avoided. In particular, in comparison to an implementation of the first or the second spring element in the form of a bar clamped on one side, the implementation according to the present invention of the first and the second spring element in the form of a parallelogram spring element offers advantages because the parallelogram spring element suppresses undesired rotation or tilted oscillation of the detection element.

Advantageous embodiments and developments of the present invention can be found in the disclosure herein.

According to a preferred embodiment of the present invention, the first and the second spring element are combination spring elements comprising the parallelogram spring element and comprising a stress relief structure, wherein the combination spring element comprising the parallelogram spring element and the stress relief structure is provided in particular in such a way that the stress relief structure is arranged or connected at the spring end of the parallelogram spring element, wherein the stress relief structure is in particular designed to be meandering, in particular comprising a plurality of portions which are each consecutively formed or arranged at right angles to one another (and connected to one another but substantially extending in parallel with the main extension plane of the substrate of the micromechanical sensor system).

According to a further preferred embodiment of the present invention, the detection element has a frame and the first and the second spring element are connected to the frame, wherein the first and the second spring element in particular respectively substantially extend in the excitation direction between the first or second anchor element and the frame. It is thereby advantageously possible to avoid an additional area requirement for the placement of the first and the second spring element.

According to a further preferred embodiment of the present invention, the first and the second spring element are arranged close to or adjacent to a frame element of the detection element that runs substantially in parallel with the excitation direction, in particular close to or in an electrode cell of the detection element that is located at the edge of the detection element. The position of this spring (i.e., of the first and second spring element) integrated in the frame can substantially be selected freely; however, it is advantageous according to the present invention if the first and the second spring element are arranged close to the uppermost or lowermost electrode cell (i.e., close to or adjacent to a frame element of the detection element that runs substantially in parallel with the excitation direction) so that, if stress is present, the outer frame piece can only minimally deform laterally and, as a result, less tensile stress or pressure stress is applied to the movable electrode bars. In particular, it can thereby be achieved that some mode groups, in particular modes in which individual or several movable detection bars oscillate, exhibit a significantly lower stress-induced frequency shift.

According to a further preferred embodiment of the present invention, the first and the second anchor element are arranged in the vicinity of a geometric center of the detection element, wherein the first and the second anchor element are in particular arranged symmetrically with respect to the geometric center of the detection element and in particular lie on a line in the excitation direction. This is relevant in particular in cases in which the mass oscillator itself has a symmetry, such as an axial symmetry with respect to a center axis. Through a correspondingly symmetrical arrangement of the anchor points, a suspension can be realized, which obtains the symmetry of the device and supports the mass oscillator centrally in a balanced manner.

In particular, it is preferred that the first and the second anchor element are spaced apart in the excitation direction (as a result, the mass oscillator is advantageously anchored at different points in the substrate, wherein both points are preferably located in the vicinity of the geometric center so that the robustness according to the present invention to substrate distortions is achieved; the choice of the distance in this case depends on additional factors, such as the design and positioning of the spring elements so that a well-balanced mounting for the mass oscillator results overall) or else directly adjoin one another or substantially coincide (as a result, the technical effect of a reduced dependence of the sensor performance on mechanical stresses is maximized, since a distortion of the substrate virtually does not change the relative distance of the anchor points; if the two anchor elements coincide and form a single anchor element to which both spring elements are connected, an advantageous simplification of the overall structure of the micromechanical sensor also results).

In this context, the geometric center is understood to mean the geometric center of gravity, i.e., the point which results by averaging all points of the detection element. The geometric center is not identical to the center of mass, but the two points are generally close to one another in the cases relevant here. Since primarily the extent of the detection element in the main extension plane is decisive here, the geometric center corresponds substantially to the center of the area of the projection of the detection element onto the main extension plane. The position specifications of the anchor elements relate in each case to the points at which the anchor elements are connected to the substrate. These points are also referred to as anchor points below.

According to a further preferred embodiment of the present invention, the rotation rate sensor has a third and fourth anchor element fixedly connected to the substrate, wherein the detection element is connected to the third anchor element via a third spring element and is connected to the fourth anchor element via a fourth spring element. In this embodiment, the mass oscillator is connected via springs to four anchor elements, whereby a particularly stable and balanced suspension can advantageously be realized. The advantage of a comparatively high insensitivity to mechanical stresses (for example due to temperature differences or temperature fluctuations) is in this case in particular realized in that at least the first and the second anchor element are arranged in the vicinity of the center. Particularly preferably, the third and the fourth anchor element are also arranged as close as possible to the center, provided that such a positioning does not oppose further design or other factors.

In particular, the first and the second anchor element are arranged within the frame and the third and the fourth anchor element are arranged outside the frame; by arranging the first and second anchor element within the frame, positioning of these anchor elements in the vicinity of the geometric center is in particular facilitated. It is also possible that the third and the fourth anchor element are likewise arranged within the frame.

According to a further preferred embodiment of the present invention, it is provided that the third and the fourth spring element are realized as a U spring arrangement with a single spring head, in particular a comparatively soft single spring head (or soft in relation to relative movements of the detection element in the detection direction).

According to a further preferred embodiment of the present invention, the third and the fourth anchor element are arranged symmetrically with respect to the center axis running through the geometric center of the detection element and in parallel with the detection direction, and the third and the fourth spring element are in particular each connected to a corner of the frame.

### BRIEF DESCRIPTION OF THE DRAWINGS

FIG. 1 shows a schematic representation of a portion of a rotation rate sensor, namely substantially a detection element, according to the related art.

FIG. 2 shows a schematic representation of a portion of such a detection element according to an exemplary embodiment of the present invention.

FIG. 3 shows a schematic representation of a portion of such a detection element according to the exemplary embodiment of the present invention in a representation in which certain oscillation modes of the detection element are shown (exaggerated).

### DETAILED DESCRIPTION OF EXAMPLE EMBODIMENTS

In the various figures, identical parts are always provided with the same reference signs and are therefore generally also named or mentioned only once.

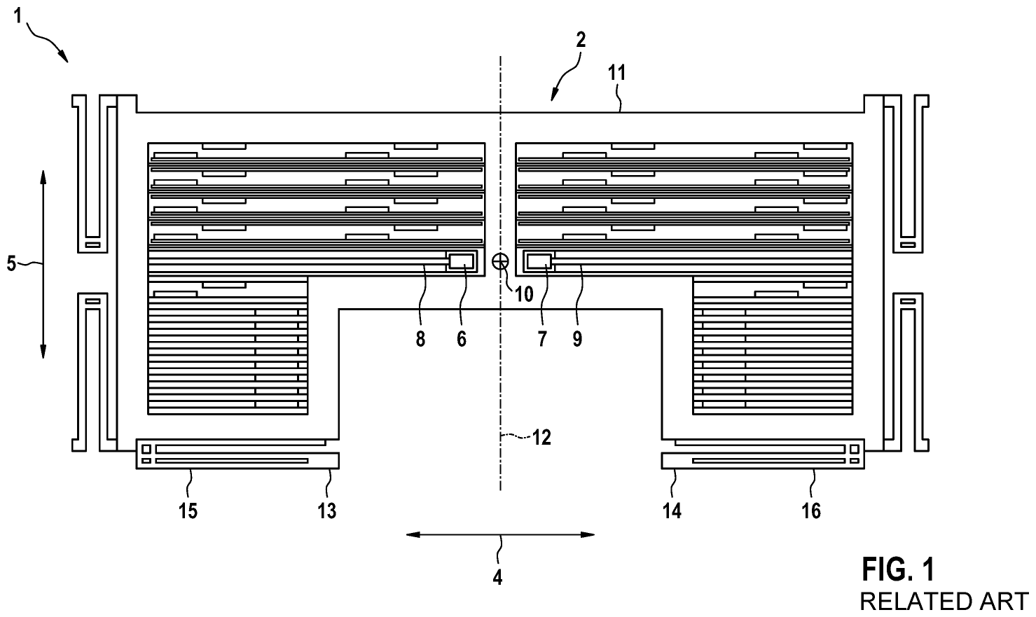

FIG. 1 schematically shows a portion of a rotation rate sensor 1, namely substantially a detection element 2, according to the related art.

The detection element 2 comprises or consists of a frame 11, which is connected to a mass oscillator or a Coriolis element (not shown) and said mass oscillator or Coriolis element in turn is connected to a drive mechanism (not shown) so that the mass oscillator can be set in oscillation in the excitation direction 4 via the drive. When the sensor 1 rotates about an axis which is not parallel to the excitation direction 4, a Coriolis force, which is directed perpendicularly to the excitation direction 4 and perpendicularly to the axis of rotation, acts on the mass oscillator. If this force has a component in the detection direction 5, this results in a deflection or at least in a force action in this direction on the mass oscillator and, due to the coupling thereof, also on the detection element 2. For measuring such a deflection or such a force action, the detection element 2 has electrodes which are displaced relative to substrate-fixed electrodes during the deflection, so that the deflection can be measured by means of an electrical signal caused thereby.

For this functional principle, it is necessary that the suspension of the detection element 2 makes such a deflection in the detection direction 5 possible. The rotation rate sensor 1 shown has four suspensions for the detection element 2 for this purpose. For the suspension, the detection element 2 is connected to springs 8, 9, 15, 16, which in turn are fixedly connected to the substrate via the anchor elements 6, 7, 13, 14.

In typical rotation rate sensors in the related art, in particular z-channel rotation rate sensors, i.e., rotation rate sensors in which the sensitive axis is perpendicular to the substrate plane (which is also referred to below as z-axis), a frame concept is usually used: In this case, there is a drive frame (not shown in FIG. 1), which makes the drive movement possible. This drive frame surrounds the so-called Coriolis frame (hereinafter also referred to as the mass oscillator and likewise not shown in FIG. 1), which, in the event of a present rotation rate about the z-axis, is responsible for generating the Coriolis force or experiences a Coriolis force due to its drive movement and due to the acting rotation rate. This Coriolis frame or mass oscillator in turn surrounds the so-called detection frame (hereinafter also referred to as detection element 2), which, in the event of a closed-loop control, is largely kept at rest via electrostatic forces (and even though force actions caused by the acting Coriolis force are present). All three frames are connected to one another via spring structures. The drive frame on the outside as well as the detection frame or the detection element 2 on the inside are connected via substrate anchors to the substrate (not specifically provided with a reference sign in FIG. 1): The detection element 2 is connected to the first anchor element 6 via the first spring element 8 and is connected to the second anchor element 7 via the second spring element 9, wherein the detection element 2 can be deflected along a detection direction 5 running in parallel with the main extension plane and perpendicularly to the excitation direction 4. Furthermore, according to FIG. 1, the rotation rate sensor 1 has a third and fourth anchor element 13, 14 fixedly connected to the substrate, wherein the detection element 2 is connected to the third anchor element 13 via a third spring element 15 and is connected to the fourth anchor element 14 via a fourth spring element 16.

According to FIG. 1, the detection element 2 furthermore has a frame 11 and a geometric center 10. The detection element 2 is in particular axially symmetrical with respect to the center axis 12 running through the center 10.

The entire movable structure, comprising the three frames and further structures, has many possible movement forms (modes) or oscillation modes. In addition to the two useful modes for drive and detection, there are in principle any number of higher-frequency parasitic modes. In the design, special attention is paid to placing these parasitic modes by design at frequencies that make interference-free operation of the sensor possible. In real-world operation, the sensor is exposed to different stress influences, for example due to temperature fluctuations or external causes. These stress influences can result in the mentioned substrate anchors (6, 7, 13, 14) being displaced relative to one another. The frequencies of the useful modes and of parasitic modes may change due to these displacements of the substrate anchors (which can lead to mechanical prestressing) and may thus cause different error patterns depending on the effect of stress.

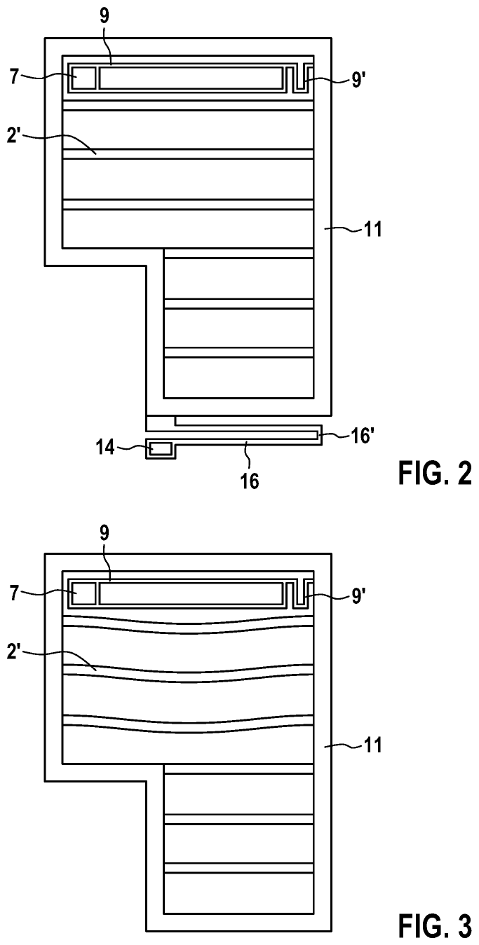

FIG. 2 shows, in a schematic representation, a portion of such a detection element 2 according to an exemplary embodiment of the present invention, wherein the center axis 12 running through the center 10 is to be imagined in particular on the left-hand side of the image shown in FIG. 2 (i.e., FIG. 2 represents only the right-hand side of the detection element 2, which is designed to be symmetrical in FIG. 1 (with respect to the center axis 12)).

The detection element 2 comprises or consists of the frame 11, which, due to its comparatively stiff coupling in the detection direction 5 to the mass oscillator (not shown) and in the event of a rotation of the sensor 1 about the sensitive z-axis, participates in the detection movement (or experiences at least the force action in the detection direction on the mass oscillator or the Coriolis element (not shown)). Again, for measuring such a deflection or such a force action, the detection element 2 has electrodes, which interact with substrate-fixed electrodes so that the deflection or the force action can be measured by means of an electrical signal caused thereby; however, these electrodes, as part of the detection element 2, and also substrate-fixed electrodes interacting therewith are not shown in FIG. 2 for the sake of simplicity; only a few movable detection bars 2′ are schematically indicated as part of the detection element 2.

FIG. 2 shows an embodiment variant of the present invention in which the entire detection element 2 has four suspensions (the first, second, third and fourth spring elements 8, 9, 15, 16 and the anchor elements 6, 7, 13, 14) with respect to its suspension or anchoring relative to the substrate and for allowing movability in the detection direction 5, FIG. 2 naturally only showing half of said suspensions, namely the second spring element 9, the second anchor element 7 as well as the fourth spring element 16 and the fourth anchor element 14.

The stress-induced frequency shift of useful modes and interference modes is greatly reduced by the present invention.

According to the present invention, the second spring element 9 (but also an analog first spring element not shown in FIG. 2) is or comprises a parallelogram spring element, i.e., the second spring element 9 (and analogously the first spring element 8) is designed as a type of parallelogram spring, at the spring end of which a meandering further stress relief structure 9′ is in particular located (i.e., the first and the second spring element 8, 9 correspond to a combination spring element comprising the parallelogram spring element 9 and the stress relief structure 9′), which connects the detection frame, i.e., the frame 11 of the detection element 2, from the inside. The parallelogram springs or the parallelogram spring elements 8, 9 suppress undesired rotation or tilted oscillation of the detection element 2. According to the present invention, the position of these parallelogram spring elements 8, 9 within the frame 11 can in particular be freely selected. However, it can be advantageous if it is selected close to the uppermost or lowermost electrode cell so that, if stress is present, the outer frame piece can only deform minimally laterally and, as a result, less tensile stress or pressure stress is applied to the movable electrode bars; a situation (or a mode) in which this advantage becomes evident is shown schematically in FIG. 3: FIG. 3 shows, only in a schematic representation, the part, shown in FIG. 2, of such a detection element 2 according to the present invention in a representation in which certain oscillation modes of the detection element 2 (with (exaggerated) deflection of individual detection bars) are shown schematically (shown by way of example are interference modes, wherein individual or several detection bars 2′ oscillate or are shown deflected; the position of the upper detection spring in combination with the stress relief structure 9′ reduce bulging of the frame 11 if stress or mechanical stresses are present; as a result, the frequency shift of this type of modes is minimized). By arranging the parallelogram spring elements 8, 9 within the frame 11 and close to the uppermost or lowermost electrode cell, it can be achieved that some mode groups, in particular modes in which individual or several movable detection bars oscillate, exhibit a significantly lower stress-induced frequency shift.

According to the present invention, due to a possible placement of the substrate anchor of the detection element 2 as close as possible to the center, a more compact design of the sensor 1 is also possible, which in principle means smaller designs and thus cost savings. Furthermore, according to the present invention, the substrate anchors can be positioned in a modified manner so that further stress relief results in the spring connection.

According to the present invention, instead of a complex folded spring (with a double spring head), a single U spring with an in particular soft single spring head is preferably used for the third and the fourth spring element 15, 16 (FIG. 2 again only shows the fourth spring element 16).

What is claimed is:

1. A rotation rate sensor, comprising:
a substrate having a main extension plane;
at least one mass oscillator, wherein the mass oscillator is connected to a drive structure via one or more spring elements and can be excited to oscillate in an excitation direction running in parallel with the main extension plane;
at least one detection element connected to the mass oscillator and a first and second anchor element connected fixedly to the substrate, wherein the detection element is connected to the first anchor element via a first spring element and is connected to the second anchor element via a second spring element wherein the detection element can be deflected along a detection direction running in parallel with the main extension plane and perpendicularly to the excitation direction, wherein the first and the second spring elements include a parallelogram spring element.

2. The rotation rate sensor according to claim 1, wherein characterized in that the first and the second spring elements are combination spring elements including the parallelogram spring element and including a stress relief structure.

3. The rotation rate sensor according to claim 1, wherein the detection element has a frame, and the first and the second spring elements are connected to the frame, wherein the first and the second spring elements respectively substantially extend in the excitation direction between the first or second anchor element and the frame.

4. The rotation rate sensor according to claim 1, wherein the first and the second spring elements are arranged close to or adjacent to a frame element of the detection element that runs substantially in parallel with the excitation direction, and close to or in an electrode cell of the detection element that is located at an edge of the detection element.

5. The rotation rate sensor according to claim 1, wherein the first and the second anchor elements are arranged in a vicinity of a geometric center of the detection element, wherein the first and the second anchor elements are arranged symmetrically with respect to the geometric center of the detection element and lie on a line in the excitation direction, wherein the first and the second anchor elements are spaced apart in the excitation direction or directly adjoin one another or substantially coincide with one another.

6. The rotation rate sensor according to claim 3, wherein the rotation rate sensor has a third and a fourth anchor element fixedly connected to the substrate, wherein the detection element is connected to the third anchor element via a third spring element and is connected to the fourth anchor element via a fourth spring element, wherein the first and the second anchor elements are arranged within the frame and the third and the fourth anchor element are arranged outside the frame (11).

7. The rotation rate sensor according to claim 1, wherein the third and the fourth spring elements are realized as a U spring arrangement with a single spring head.

8. The rotation rate sensor according to claim 6, wherein the third and the fourth anchor elements are arranged symmetrically with respect to a center axis running through the geometric center of the detection element and in parallel with the detection direction, and wherein the third and the fourth spring elements are each connected to a corner of the frame.
